(19) United States
(12) Patent Application Publication
(10) Pub. No.: US 2026/0079584 A1
(43) Pub. Date: Mar. 19, 2026

(54) ELECTRONIC DEVICE INCLUDING ANTENNA FOR TRANSMITTING AND RECEIVING RADAR SIGNAL

(71) Applicant: Samsung Electronics Co., Ltd., Suwon-si (KR)

(72) Inventors: Hyewon JO, Suwon-si (KR); Namjun Cho, Suwon-si (KR); Hyoseok Na, Suwon-si (KR)

(73) Assignee: Samsung Electronics Co., Ltd., Suwon-si (KR)

(21) Appl. No.: 19/397,460

(22) Filed: Nov. 21, 2025

Related U.S. Application Data
(63) Continuation of application No. PCT/KR2024/006868, filed on May 21, 2024.

(30) Foreign Application Priority Data
May 22, 2023 (KR) 10-2023-00655460
Jun. 23, 2023 (KR) 10-2023-0081329

(51) Int. Cl. G06F 3/01; G01S 13/50; G01S 13/88; H01Q 1/22; H01Q 9/04; H01Q 21/06

(52) U.S. Cl. CPC G06F 3/017; G01S 13/50; G01S 13/88; H01Q 1/22; H01Q 9/0407; H01Q 21/065

(57) ABSTRACT

An electronic device includes: a display panel including pixels; an antenna array disposed to overlap the display panel; a connection board coupled to a side of the display panel; a display driver circuit on the connection board and configured to drive the pixels to display a screen on the display panel; a main printed circuit board; a flexible printed circuit board extending to connect between the main printed circuit board and the connection board; a signal processing circuit on the main printed circuit board; a first front end circuit on the connection board to be on a first side of the display driver circuit, and operatively connected to the signal processing circuit and the antenna array; and a second front end circuit on the connection board to be on a second side of the display driver circuit, and operatively connected to the signal processing circuit and the antenna array.

### CROSS-REFERENCE TO RELATED APPLICATIONS

This application is a continuation of International Application No. PCT/KR2024/006868, filed on May 21, 2024, which is based on and claims priority to Korean Patent Application No. 10-2023-0065460, filed on May 22, 2023, and Korean Patent Application No. 10-2023-0081329, filed on Jun. 23, 2023, in the Korean Intellectual Property Office, the disclosures of which are incorporated by reference herein in their entireties.

### BACKGROUND

### 1. Field

The disclosure relates to an electronic device including an antenna disposed on a display for transmitting and receiving a radar signal.

### 2. Description of Related Art

A user input interface for an electronic device may use a method using touch, voice, pen input, or Bluetooth. However, most electronic devices mainly rely on a touch-type input interface, and a wearable electronic device may employ a touch method as the only input interface.

An electronic device may use a motion sensing-type input interface for recognizing a user's gesture. A motion sensing method may be used as an input method by associating a series of sequences or commands with a gesture, such as an air motion function implemented in a pen.

For recognizing a gesture in a motion sensing method, a camera or radar may be used. A method using radar measures distance, speed and/or direction using the difference between a transmitted radio wave and a radio wave received and reflected from a target, which may have advantages of being inexpensive, consuming low current, and being free from personal privacy issues.

The above-described information may be provided as related art for the purpose of helping understanding of the disclosure. No claim or determination is made as to whether any of the foregoing is applicable as background art in relation to the disclosure.

According to an embodiment of the disclosure, an electronic device may include a display panel including a plurality of pixels, an antenna array disposed to overlap the display panel, a connection board coupled to a side of the display panel, a display driver circuit disposed on the connection board and configured to drive the plurality of pixels to display a screen on the display panel, a first circuit board, a second circuit board extending to connect between the first circuit board and the connection board, a signal processing circuit disposed on the first circuit board, a first front-end circuit disposed on the connection board to be positioned on a first side of the display driver circuit and operatively connected to the signal processing circuit and the antenna array, and a second front-end circuit disposed on the connection board to be positioned on a second side of the display driver circuit and operatively connected to the signal processing circuit and the antenna array.

According to an embodiment of the disclosure, an electronic device may include a display panel including a plurality of pixels, an antenna array disposed to overlap the display panel, a first circuit board, a signal processing circuit disposed on the first circuit board, a second circuit board extending to connect between the first circuit board and the display panel, a display driver circuit disposed on the second circuit board and configured to drive the plurality of pixels to display a screen on the display panel, a first front-end circuit disposed on the second circuit board to be positioned on a first side of the display driver circuit and operatively connected to the signal processing circuit and the antenna array, and a second front-end circuit disposed on the second circuit board to be positioned on a second side of the display driver circuit and operatively connected to the signal processing circuit and the antenna array.

### BRIEF DESCRIPTION OF DRAWINGS

FIG. 1 is a block diagram illustrating an electronic device in a network environment according to an embodiment of the disclosure.

FIG. 2A is a cross-sectional view schematically illustrating an electronic device according to a comparative embodiment of the disclosure.

FIG. 2B is a perspective view illustrating the structure of an electronic device according to a comparative embodiment of the disclosure.

FIG. 3A is an exploded view illustrating an electronic device according to an embodiment of the disclosure.

FIG. 3B is a block diagram illustrating an electronic device according to an embodiment of the disclosure.

FIG. 4A is a cross-sectional view schematically illustrating an electronic device according to a comparative embodiment of the disclosure.

FIG. 4B is a plan view illustrating a radar circuit according to a comparative embodiment of the disclosure.

FIG. 5 is a connection structure diagram illustrating an electronic device according to an embodiment of the disclosure.

FIG. 6A is a schematic view illustrating a signal processing circuit according to an embodiment of the disclosure.

FIG. 6B is a schematic view illustrating a front-end circuit according to an embodiment of the disclosure.

FIG. 7 is a block diagram illustrating an electronic device according to an embodiment of the disclosure.

FIG. 8 is a block diagram illustrating an electronic device according to an embodiment of the disclosure.

FIG. 9A is a signal flowchart illustrating an electronic device according to an embodiment of the disclosure.

FIG. 9B is a block diagram illustrating an electronic device according to an embodiment of the disclosure.

FIG. 10A is a signal flowchart illustrating an electronic device according to an embodiment of the disclosure.

FIG. 10B is a block diagram illustrating an electronic device according to an embodiment of the disclosure.

FIG. 11 is a state view illustrating a gesture detection operation of an electronic device according to an embodiment of the disclosure.

### DETAILED DESCRIPTION

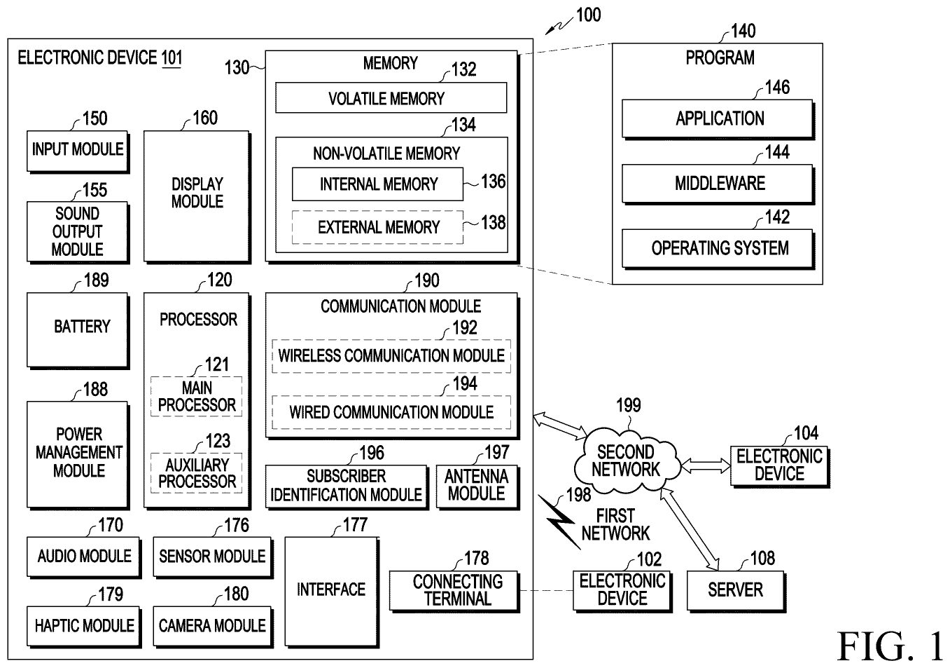

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

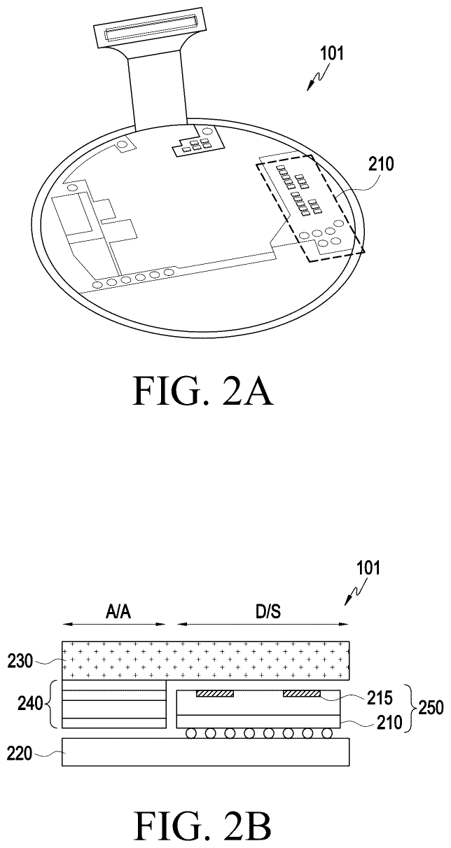

FIG. 2A is a cross-sectional view schematically illustrating an electronic device 101 according to a comparative embodiment of the disclosure. FIG. 2B is a perspective view illustrating the structure of an electronic device 101 according to a comparative embodiment of the disclosure.

Referring to FIGS. 2A and 2B, an electronic device 101 according to an embodiment may include an antenna-in-package (AiP) module 250 in which an antenna 215 and a radar circuit 210 are integrated as a package. The AiP module 250 according to an embodiment may be disposed on one side of a display panel 240.

In an embodiment, a radar signal of the antenna 215 may be radiated toward the front of the display panel 240. Accordingly, since a user's gesture corresponding to the display panel 240 displaying a visual screen may be recognized, convenience may be achieved.

For example, the antenna 215 may transmit or receive a gesture detection signal configured to operate in a frequency band of 60 GHz or higher. For example, the radar signal of the antenna 215 may be a signal corresponding to a millimeter wave (mmWave).

In an embodiment, the AiP module 250 in which the antenna 215 and the radar circuit 210 are integrated as a package may be disposed in the electronic device 101 while removing a partial area of the display panel 240. In an embodiment, the antenna 215 and the radar circuit 210 may be disposed on the side of the display panel 240. In an embodiment, the antenna 215 may radiate a radar signal through a glass layer 230 covering an image display layer of the display panel 240. In an embodiment, the AiP module 250 may be disposed on a first circuit board 220.

According to this arrangement structure, the path length between the antenna 215 and the radar circuit 210 is short, resulting in low feed loss, and thus radar performance may be secured. However, the AiP module 250 transmitting a radar signal in the millimeter wave (mmWave) band may have a size of 6.5 mm×5.0 mm for a 1Tx-3Rx type and a size of 15 mm×15 mm for a 2Tx-4Rx type, which increase the dead space (D/S) of the display panel 240 and reduce the active area (A/A) of the display panel.

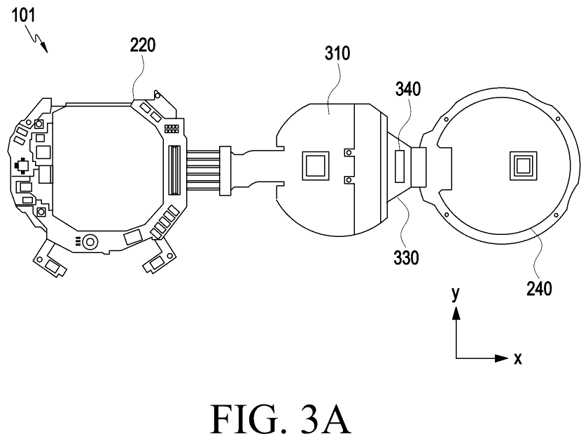

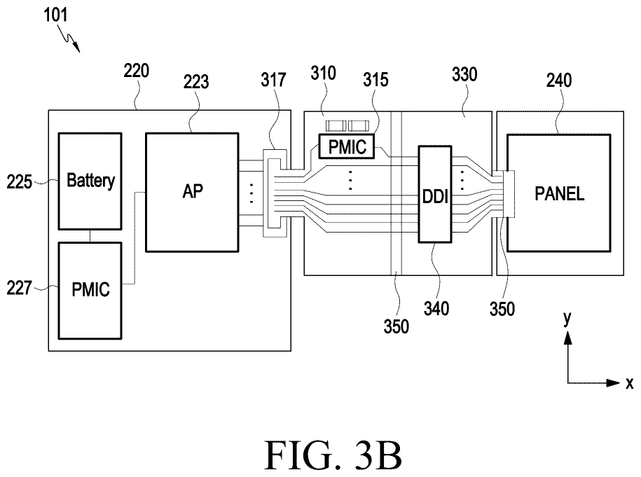

FIG. 3A is an exploded view illustrating an electronic device 101 according to an embodiment of the disclosure. FIG. 3B is a block diagram illustrating an electronic device 101 according to an embodiment of the disclosure.

Referring to FIGS. 3A and 3B, an electronic device 101 according to an embodiment may include a first circuit board 220, a second circuit board 310, a display panel 240, a connection board 330, and/or a display driver circuit 340.

The display panel 240 according to an embodiment may have a shape extending in a planar direction. In an embodiment, the display panel 240 may be formed in a circular shape as illustrated, but may be formed in various shapes such as a triangular shape or a rectangular shape.

The connection board 330 according to an embodiment may be coupled to one side of the display panel 240. In an embodiment, a circuit or an integrated circuit (IC) may be disposed on the connection board 330. In an embodiment, the connection board 330 may be coupled to the display panel 240 through an anisotropic conductive film (ACF) adhesion 350 and connected to the display panel 240 to transmit or receive signals.

The connection board 330 according to an embodiment may be coupled to the second circuit board 310 through the ACF adhesion 350 and connected to the second circuit board 310 to transmit or receive signals.

For example, the display panel 240 may extend in a first direction (e.g., x-axis direction) and a second direction (e.g., y-axis direction), and the display panel 240 may extend relatively longer in the second direction (e.g., y-axis direction) perpendicular to the first direction (e.g., x-axis direction) compared to the first direction (e.g., x-axis direction) to which the connection board 330 is connected. For example, the display panel 240 may have a rectangular shape extending relatively longer in the second direction (e.g., y-axis direction) compared to the first direction (e.g., x-axis direction). For example, the connection board 330 and the display driver circuit 340 to be described below may be connected to one side along the first direction (e.g., x-axis direction) of the display panel 240.

In an embodiment, the connection board 330 may be a chip on film (COF) method in which a film is coupled to the side or rear surface of the display panel 240. In an embodiment, the connection board 330 may be a chip on plastic (COP) method in which a polyimide (PI) board is integrally coupled to and extends from the display panel 240. In an embodiment, the connection board 330 may be a chip on glass (COG) method in which a glass board is integrally coupled to and extends from the display panel 240.

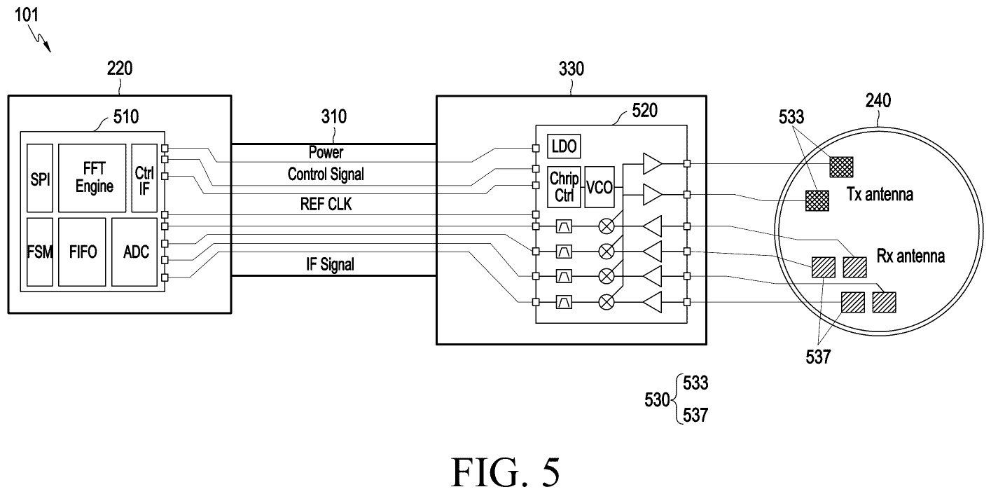

The connection board 330 according to an embodiment may be integrated with and included in the second circuit board 310. For example, the display driver circuit 340, the radar circuit (e.g., the radar circuit 210 of FIG. 2A) and/or the front-end circuit (e.g., the front-end circuit 520 of FIG. 5) may be disposed on the second circuit board 310.

The display driver circuit 340 according to an embodiment may be disposed on the connection board 330. In an embodiment, the display driver circuit 340 may be a circuit driving a plurality of pixels included in the display panel 240 to display a screen on the display panel 240. In an embodiment, the display driver circuit 340 may drive the plurality of pixels included in the display panel 240 by converting a digital signal received from the AP 223 (e.g., the processor 120 of FIG. 1) into RGB analog values.

In an embodiment, the display driver circuit 340 may be formed to extend long in a direction crossing the direction in which the display driver circuit 340 or the connection board 330 is connected to one side of the display panel 240. In an embodiment, the coupling between the connection board 330 and the display panel 240 according to the anisotropic conductive film (ACF) adhesion 350 may extend in the y-axis direction in which the display panel 240 and/or the display driver circuit 340 extends long. In an embodiment, the coupling between the connection board 330 and the display panel 240 may extend in the y-axis direction crossing the x-axis direction in which one side of the display panel 240 is connected to the display driver circuit 340 or the connection board 330. Accordingly, it may be advantageous for circuit packaging and resistance reduction for the connection between the display driver circuit 340 and the plurality of pixels included in the display panel 240.

An application processor (AP) 223, and a power management integrated circuit (PMIC) 227 providing power from a battery 225 to the AP 223 may be disposed on the first circuit board 220 according to an embodiment. In an embodiment, other components whose operations are controlled by the AP 223 may be further disposed on the first circuit board 220.

The second circuit board 310 (flexible printed circuit board, FPCB) according to an embodiment may be formed to connect between the first circuit board 220 and the connection board 330. The second circuit board 310 according to an embodiment may be at least partially relatively more flexible than the first circuit board 220, and at least a portion may be bent. For example, two opposite ends of the second circuit board 310 respectively coupled to the first circuit board 220 and/or the connection board 330 may be bent so that the second circuit board 310 may be disposed to overlap the first circuit board 220 and/or the connection board 330 in the vertical direction. For example, the second circuit board 310 may be formed of a material including liquid crystal polymer (LCP).

In an embodiment, the second circuit board 310 may be connected to the first circuit board 220 through a connector 317 (e.g., a board-to-board connector). In an embodiment, the second circuit board 310 may receive power and/or control signals from the first circuit board 220. In an embodiment, the second circuit board 310 may be coupled to the connection board 330 through an anisotropic conductive film (ACF) adhesion 350 and connected to the connection board 330 to transmit or receive signals.

A power management integrated circuit (PMIC) 315 providing power to the display panel 240 may be disposed on the second circuit board 310 according to an embodiment. In an embodiment, the PMIC 315 disposed on the second circuit board 310 may receive power from the battery 225 connected to the first circuit board 220 and provide power to the display driver circuit 340 or the display panel 240.

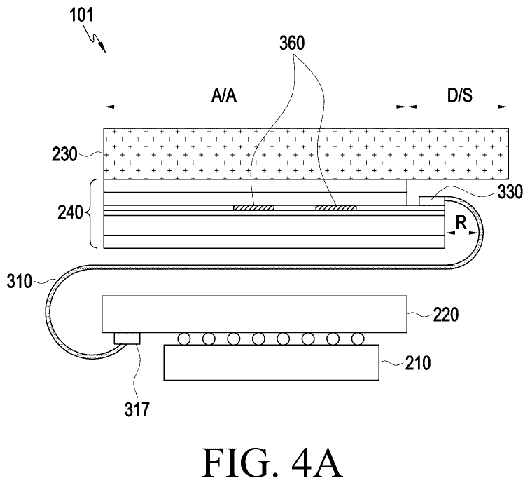

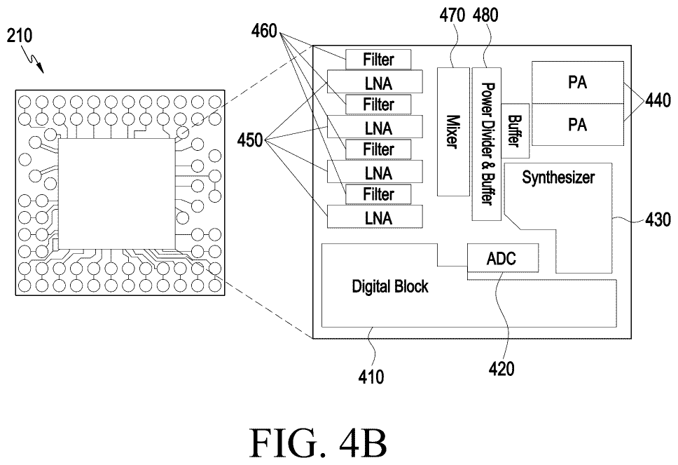

FIG. 4A is a cross-sectional view schematically illustrating an electronic device 101 according to a comparative embodiment of the disclosure. FIG. 4B is a plan view illustrating a radar circuit 210 according to a comparative embodiment of the disclosure.

Referring to FIGS. 4A and 4B, an electronic device 101 according to a comparative embodiment may include an in-display type antenna array 360 in which an antenna overlaps the display panel 240 and a non-AiP type radar circuit 210 excluding the antenna array 360.

In an embodiment, the antenna array 360 may be positioned inside the display module 160 to overlap the display panel 240. For example, the antenna array 360 may be attached to the top or lower surface of the display panel 240 in a film form. In an embodiment, the antenna array 360 may radiate a radar signal upward from the display panel 240.

In an embodiment, a feed line extending from at least one patch may be connected to the antenna array 360, and the feed line may be formed by patterning with a conductive material within the laminated structure of the display panel 240. For example, the feed line may be formed by patterning together with electrodes of a touch screen panel.

The radar circuit 210 according to an embodiment may be a circuit corresponding to a radio frequency integrated circuit (RFIC) chip providing a radio frequency (RF) signal to the antenna array 360.

The radar circuit 210 according to an embodiment may be disposed on the first circuit board 220. In an embodiment, the first circuit board 220 may be connected to the display panel 240 and/or the antenna array 360 through the second circuit board 310 and the connection board 330. In an embodiment, two opposite ends of the second circuit board 310 may be bent to be stacked to overlap the connection board 330 and/or the first circuit board 220 in the vertical direction. For example, one end of the second circuit board 310 may be bent according to a bending radius (R) and coupled to the connection board 330.

The radar circuit 210 according to an embodiment may include a digital block 410, an analog to digital converter (ADC) 420, a synthesizer 430, a power amplifier (PA) 440, a low noise amplifier (LNA) 450, a filter 460 (e.g., a low pass filter (LPF), a high pass filter (HPF) and/or a band pass filter (BPF)), a mixer 470, and/or a power divider & buffer 480.

For example, the digital block 410 processing digital signals may occupy about ⅓ of the area of the radar circuit 210. For example, RF blocks 430, 440, 450, 460, 470, and 480 processing radar signals may occupy about ⅔ of the area of the radar circuit 210.

According to the structure of the electronic device 101 according to an embodiment, the dead space (D/S) of the display panel 240 is decreased to an area corresponding to the bending radius (R) of the second circuit board 310, and accordingly the active area (A/A) of the display panel 240 is extended, which may have advantageous effects in terms of design or aesthetics.

In the electronic device 101 according to an embodiment, the radar circuit 210 disposed on the first circuit board 220 may have a structure connected to the antenna array 360 through the second circuit board 310 and the connection board 330, and accordingly the path between the radar circuit 210 and the antenna array 360 may increase, increasing feed loss of the radar signal in the millimeter wave (mmWave) band.

In the electronic device 101 according to an embodiment, the commercialized radar circuit 210 for the millimeter wave (mmWave) band (e.g., about 60 GHz) disposed on the first circuit board 220 may occupy a relatively large area (e.g., 6 mm×6 mm) and, when space on the first circuit board 220 is limited, it may be difficult to secure the placement area for the radar circuit 210.

According to a comparative embodiment (e.g., the embodiment illustrated in FIGS. 2A and 2B), when the electronic device 101 uses the AiP type antenna 215 and radar circuit 210, feed loss is small but the dead space (D/S) of the display panel 240 may increase. According to another comparative embodiment (e.g., the embodiment illustrated in FIGS. 4A and 4B), when the electronic device 101 includes the in-display type antenna array 360 and non-AiP type radar circuit 210, the dead space (D/S) of the display panel 240 is decreased but feed loss may increase. Further, in both comparative embodiments, since the area of the commercialized radar circuit 210 is large, the placement efficiency for the first circuit board 220 may be decreased.

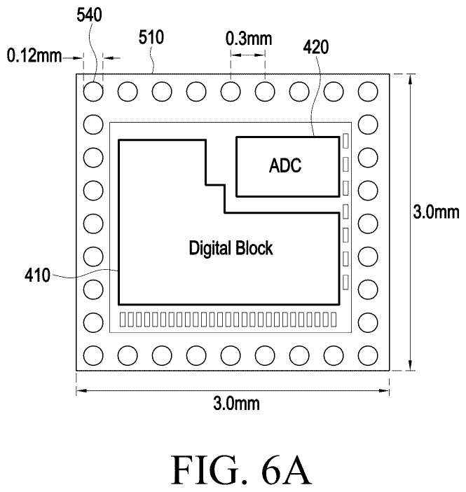

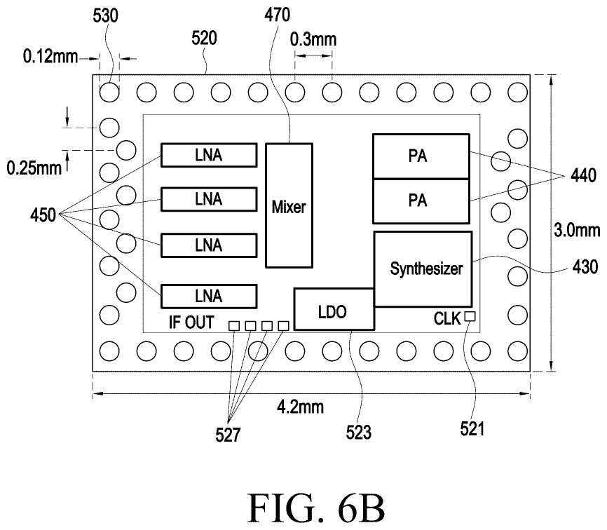

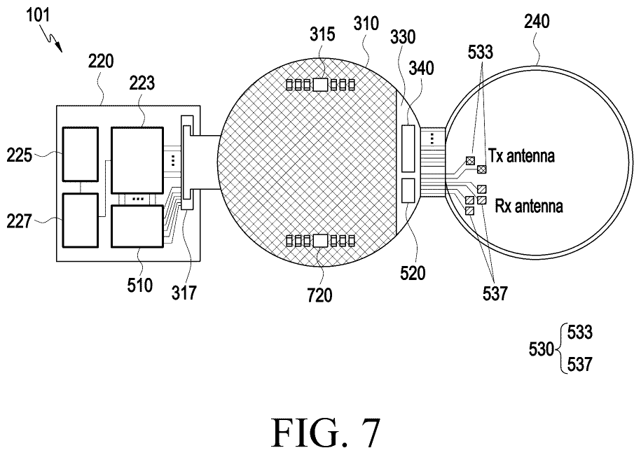

FIG. 5 is a connection structure diagram illustrating an electronic device 101 according to an embodiment of the disclosure. FIG. 6A is a schematic view illustrating a signal processing circuit 510 according to an embodiment of the disclosure. FIG. 6B is a schematic view illustrating a front-end circuit 520 according to an embodiment of the disclosure. FIG. 7 is a block diagram illustrating an electronic device 101 according to an embodiment of the disclosure.

Referring to FIGS. 5 to 7, an electronic device 101 according to an embodiment may include a first circuit board 220, a second circuit board 310, a connection board 330, and/or a display panel 240. In an embodiment, the electronic device 101 may include a signal processing circuit 510 disposed on the first circuit board 220 and/or a front-end circuit 520 disposed on the connection board 330.

The first circuit board 220 according to an embodiment may be coupled with the second circuit board 310 through a connector 317, and accordingly the AP 223 and/or the signal processing circuit 510 may be electrically connected to the second circuit board 310. In an embodiment, the connection board 330 may be coupled to the display panel 240, and accordingly the display driver circuit 340 may be electrically connected to a plurality of pixels included in the display panel 240, and the front-end circuit 520 may be electrically connected to the antenna array 530 (e.g., the antenna array 360 of FIG. 4A).

According to an embodiment, the radar circuit (e.g., the radar circuit 210 of FIG. 4B) may be separated into the signal processing circuit 510 of FIG. 6A and the front-end circuit 520 of FIG. 6B. In an embodiment, the diameter of bump balls 540 of the signal processing circuit 510 and the front-end circuit 520 may be changed from about 350 [μm] to about 120 [μm]. In an embodiment, the pitch between bump balls 540 of the signal processing circuit 510 and the front-end circuit 520 may be changed from about 500 [μm] to about 300 [μm]. In an embodiment, the signal processing circuit 510 may be formed with a size of about 3 mm×about 3 mm, about ⅓ the size of the radar circuit 210. In an embodiment, the front-end circuit 520 may be formed with a size of about 3 mm×about 4.2 mm, about ⅔ the size of the radar circuit 210. In an embodiment, the display driver circuit 340 may be formed with a size of about 3 mm×about 8.5 mm.

The front-end circuit 520 according to an embodiment may be disposed on the connection board 330 connected to one side of the display panel 240 and may be electrically connected to the antenna array 530 disposed overlapping the display panel 240. In an embodiment, the front-end circuit 520 may be disposed on the connection board 330 to be positioned on one side of the display driver circuit 340.

The signal processing circuit 510 according to an embodiment may be disposed on the first circuit board 220 and may be electrically connected to the front-end circuit 520 through the second circuit board 310 connecting between the first circuit board 220 and the connection board 330.

The antenna array 530 according to an embodiment may include at least one transmission patch 533 transmitting a radar signal and at least one reception patch 537 receiving a radar signal. For example, the antenna array 530 may have a 2Tx-4Rx structure including two transmission patches 533 and four reception patches 537. For example, the two transmission patches 533 and four reception patches 537 may be disposed spaced apart by a designated distance.

At least one transmission patch 533 and/or at least one reception patch 537 of the antenna array 530 according to an embodiment may be disposed on top of a touch screen panel layer of the display panel 240 or between the touch screen panel layer and an image display layer. At least one transmission patch 533 and/or at least one reception patch 537 of the antenna array 530 according to an embodiment may be disposed below a glass layer (e.g., the glass layer 230 of FIG. 2B) or may be disposed on top of the glass layer 230. In an embodiment, the antenna array 530 may be disposed in various ways according to the structure and shape of the electronic device 101, and as long as it has a structure capable of detecting a gesture action occurring in front of the display panel 240, it may be changed and applied without being limited to the position on the cross-section of the display panel 240.

The front-end circuit 520 according to an embodiment may transmit to or receive from the antenna array 530 a radar signal radiated or received through the antenna array 530. For example, the radar signal may be set to a frequency included in a first frequency band corresponding to a relatively high frequency.

The front-end circuit 520 according to an embodiment may include a chirp generator generating a chirp transmitted to the antenna array 530, a power amplifier (PA) 440 amplifying a radar signal radiated or received through the antenna array 530, and/or a mixer 470 mixing the radar signal. In an embodiment, the front-end circuit 520 may include, corresponding to the transmission patch 533 among the antenna array 530, a chirp generator, a voltage controlled oscillator (VCO), a synthesizer 430, a power amplifier (PA) 440, an RF (radio frequency) circuit, a low dropout (LDO) 523 as a power block, and/or a chirp generator control circuit. In an embodiment, the front-end circuit 520 may include, corresponding to the reception patch 537 among the antenna array 530, a low noise amplifier (LNA) 450, a mixer 470, and/or a baseband filter (e.g., the filter 460 of FIG. 4B, e.g., a low pass filter (LPF), a high pass filter (HPF) and/or a band pass filter (BPF)). In an embodiment, the front-end circuit 520 may include a terminal 527 outputting an intermediate frequency (IF) signal and/or a terminal 521 receiving a clock signal.

The signal processing circuit 510 according to an embodiment may transmit or receive an IF signal to or from the front-end circuit 520. For example, the IF signal may be set to a frequency included in a second frequency band, which is relatively lower than the first frequency band.

The front-end circuit 520 according to an embodiment may receive a command signal to change the frequency of the synthesizer 430 from the signal processing circuit 510, generate a chirp accordingly, amplify the transmission chirp signal through the PA 440, and transmit it to the antenna array 530 (e.g., the transmission patch 533). The front-end circuit 520 according to an embodiment may amplify a reception signal reflected from an object and received through the antenna array 530 (e.g., the reception patch 537), mix the transmission chirp signal and the reception chirp signal to generate an IF signal, and transmit the generated IF signal to the signal processing circuit 510. For example, the frequency of the IF signal may be less than 2 [MHz] based on a distance of 1 [m], which may have relatively low feed loss compared to the radar signal in the millimeter wave (mmWave) band. For example, the front-end circuit 520 may be disposed adjacent to the antenna array 530 to reduce feed loss.

The signal processing circuit 510 according to an embodiment may generate a control signal changing the frequency of the transmission signal of the front-end circuit 520 and receive the IF signal down-mixed by the front-end circuit 520. In an embodiment, the signal processing circuit 510 may convert the IF signal, which is an analog signal, to a digital signal through an analog to digital converter (ADC) 420 and transmit it to the AP 223, or may fast Fourier transform (FFT) the IF signal through an internal FFT engine and transmit it to the AP 223.

In an embodiment, the signal processing circuit 510 may receive power from the battery 225 through the PMIC 227 disposed on the first circuit board 220 of the electronic device 101. In an embodiment, the front-end circuit 520 may receive power from the PMIC 227 disposed on the first circuit board 220 and use an internal LDO 523 as a power source, or may receive power through an external LDO 720 disposed on the second circuit board 310.

The signal processing circuit 510 according to an embodiment may transmit power, control signals, and/or a reference clock signal (REF CLK) to the front-end circuit 520. The front-end circuit 520 according to an embodiment may transmit an IF signal to the signal processing circuit 510.

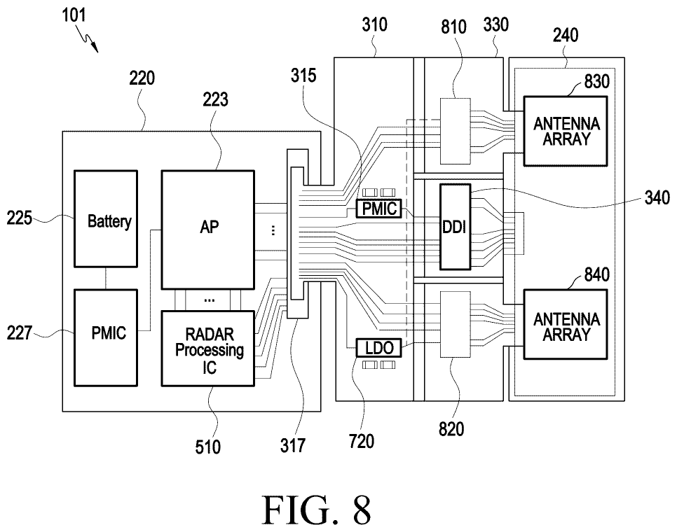

FIG. 8 is a block diagram illustrating an electronic device 101 according to an embodiment of the disclosure.

Referring to FIG. 8, an electronic device 101 according to an embodiment may include a first circuit board 220, a second circuit board 310, a connection board 330, and/or a display panel 240. In an embodiment, the electronic device 101 may include a first front-end circuit 810 and a second front-end circuit 820 disposed on the connection board 330. In an embodiment, the first front-end circuit 810 and the second front-end circuit 820 may be respectively positioned on one side and another side of the display driver circuit 340 along the direction in which the display driver circuit 340 extends. For example, the first front-end circuit 810 and the second front-end circuit 820 may be separated circuits from the front-end circuit 520. For example, the first front-end circuit 810 may include components for signal transmission. For example, the second front-end circuit 820 may include components for signal reception. However, the components included in the first front-end circuit 810 and the second front-end circuit 820 are not limited thereto.

The first front-end circuit 810 according to an embodiment may be disposed on the connection board 330 to be positioned on one side of the display driver circuit 340. In an embodiment, the first front-end circuit 810 may be operatively connected to the signal processing circuit 510 and the antenna array 830 and 840 (e.g., the antenna array 530 of FIG. 5).

The second front-end circuit 820 according to an embodiment may be disposed on the connection board 330 to be positioned on another side of the display driver circuit 340. In an embodiment, the second front-end circuit 820 may be operatively connected to the signal processing circuit 510 and the antenna array 830 and 840.

The antenna array 830 and 840 according to an embodiment may include a first antenna array 830 operatively connected to the first front-end circuit 810 and/or a second antenna array 840 operatively connected to the second front-end circuit 820. In an embodiment, the first antenna array 830 and/or the second antenna array 840 may include at least one of a transmission patch (e.g., the transmission patch 533 of FIG. 5) or a reception patch (e.g., the reception patch 537 of FIG. 5).

The display driver circuit 340 according to an embodiment may be disposed between the first front-end circuit 810 and the second front-end circuit 820 and may be electrically connected to the display panel 240 on one side of the display panel 240.

In an embodiment, to reduce resistance in the control signal line between the display driver circuit 340 and the display panel 240, the connection board 330 may have a shape extending in a direction crossing the direction extending to one side of the display panel 240. In an embodiment, the connection board 330 may be connected to the display panel 240 as short as possible in a narrow area. According to the structure of the electronic device 101 according to an embodiment, the display driver circuit 340 may be disposed in the center of the connection board 330, and accordingly low resistance may be maintained.

The electronic device 101 according to an embodiment, by disposing the first front-end circuit 810 and the second front-end circuit 820 adjacent to the antenna array 830 and 840, may reduce feed loss by reducing the feed line length compared to a structure in which the radar circuit (e.g., the radar circuit 210 of FIG. 4B) is disposed on the first circuit board 220. Further, the electronic device 101 according to an embodiment, compared to a structure in which the radar circuit 210 is disposed on the first circuit board 220, by separating into the signal processing circuit 510, the first front-end circuit 810, and the second front-end circuit 820, may enable more efficient space utilization.

In an embodiment, a power management integrated circuit (PMIC) 227 may be disposed on the first circuit board 220. In an embodiment, the first front-end circuit 810 and the second front-end circuit 820 may receive power from the PMIC 227 disposed on the first circuit board 220. In an embodiment, the first front-end circuit 810 and the second front-end circuit 820 may receive power through an external LDO 720 disposed on the second circuit board 310.

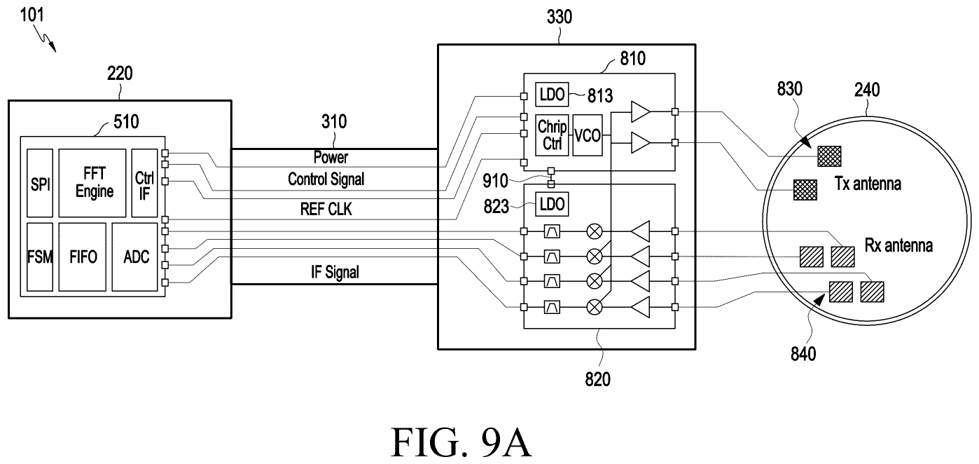

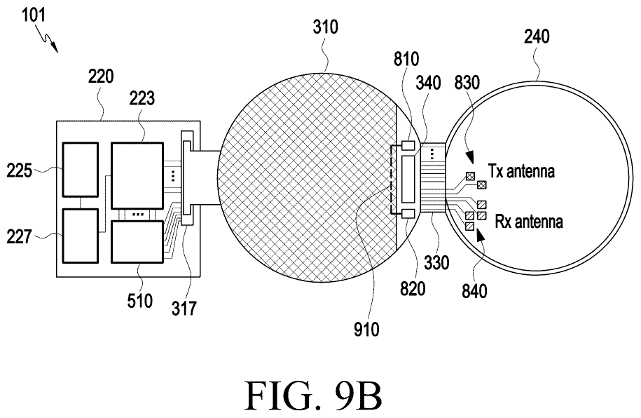

FIG. 9A is a signal flowchart illustrating an electronic device 101 according to an embodiment of the disclosure. FIG. 9B is a block diagram illustrating an electronic device 101 according to an embodiment of the disclosure.

Referring to FIGS. 9A and 9B, in an electronic device 101 according to an embodiment, the first front-end circuit 810 may be operatively connected to the first antenna array 830 of the antenna array 830 and 840. In an embodiment, the first antenna array 830 may include at least one transmission patch (e.g., the transmission patch 533 of FIG. 5). For example, the first front-end circuit 810 may be operatively connected to at least one transmission patch 533.

In the electronic device 101 according to an embodiment, the second front-end circuit 820 may be operatively connected to the second antenna array 840 of the antenna array 830 and 840. In an embodiment, the second antenna array 840 may include at least one reception patch (e.g., the reception patch 537 of FIG. 5). For example, the second front-end circuit 820 may be operatively connected to at least one reception patch 537.

The first front-end circuit 810 according to an embodiment may include a chirp generator, a voltage controlled oscillator (VCO), a synthesizer (e.g., the synthesizer 430 of FIG. 4B), a power amplifier (PA), a radio frequency (RF) circuit, a low dropout (LDO) as a power block (e.g., the LDO 523 of FIG. 6B), and/or a chirp generator control circuit.

The second front-end circuit 820 according to an embodiment may include a low dropout (LDO) as a power block (e.g., the LDO 523 of FIG. 6B), a low noise amplifier (LNA) (e.g., the LNA 450 of FIG. 4B), a mixer (e.g., the mixer 470 of FIG. 4B), and a baseband filter (e.g., the filter 460 of FIG. 4B, e.g., a low pass filter (LPF), a high pass filter (HPF) and/or a band pass filter (BPF)).

In an embodiment, the second front-end circuit 820 may be connected to the first front-end circuit 810 to receive from the first front-end circuit 810 a signal related to a transmission signal radiated through at least one transmission patch 533. In an embodiment, the first front-end circuit 810 and the second front-end circuit 820 may be connected through a VCO circuit 910 to transmit or receive a VCO signal related to a transmission signal radiated through at least one transmission patch 533.

In an embodiment, the second front-end circuit 820 may generate an IF signal by down-converting the frequency of a reception signal received through the second antenna array 840 of a signal transmitted through the first front-end circuit 810. In an embodiment, the second front-end circuit 820 may transmit the IF signal to the signal processing circuit 510.

In an embodiment, a power management integrated circuit (PMIC) 227 may be disposed on the first circuit board 220. In an embodiment, the first front-end circuit 810 and the second front-end circuit 820 may receive power from the PMIC 227 disposed on the first circuit board 220. In an embodiment, the first front-end circuit 810 and the second front-end circuit 820 may use power through LDOs 813 and 823 disposed internally.

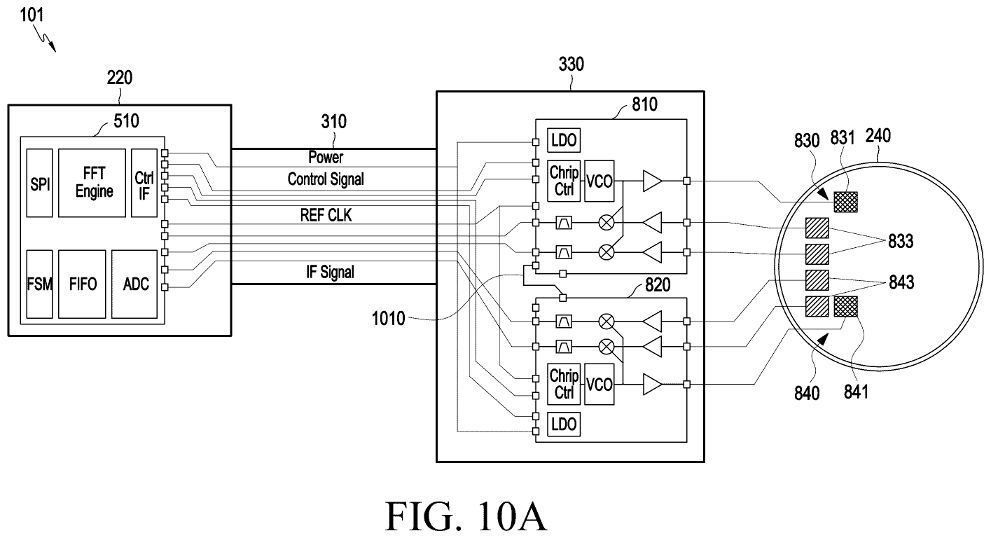

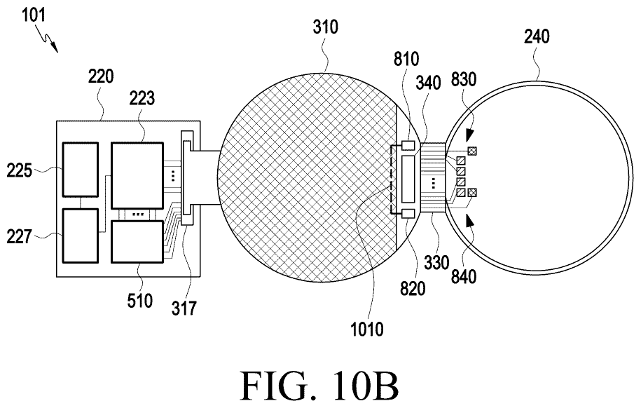

FIG. 10A is a signal flowchart illustrating an electronic device 101 according to an embodiment of the disclosure. FIG. 10B is a block diagram illustrating an electronic device 101 according to an embodiment of the disclosure.

Referring to FIGS. 10A and 10B, in an electronic device 101 according to an embodiment, the first front-end circuit 810 may be operatively connected to the first antenna array 830 including at least one first transmission patch 831 and at least one first reception patch 833. In an electronic device 101 according to an embodiment, the second front-end circuit 820 may be operatively connected to the second antenna array 840 including at least one second transmission patch 841 and at least one second reception patch 843.

The antenna array 830 and 840 according to an embodiment may each include at least one transmission patch 831 and 841 and at least one reception patch 833, 843, and may be respectively connected to the first front-end circuit 810 or the second front-end circuit 820. In an embodiment, the electronic device 101 may include a plurality of antenna arrays 830 and 840 including transmission patches 831 and 841, and may cascade them to operate continuously, thereby increasing the number of channels to secure signal to noise ratio (SNR) and high resolution.

In the electronic device 101 according to an embodiment, the first front-end circuit 810 and the second front-end circuit 820 may be connected to each other to transmit or receive a signal related to the sync of a radar signal radiated through or received from the antenna array 830 and 840. In an embodiment, the first front-end circuit 810 and the second front-end circuit 820 may be connected to each other through a sync circuit 1010 to transmit or receive sync signals related to clock sync and/or local oscillator (LO) sync.

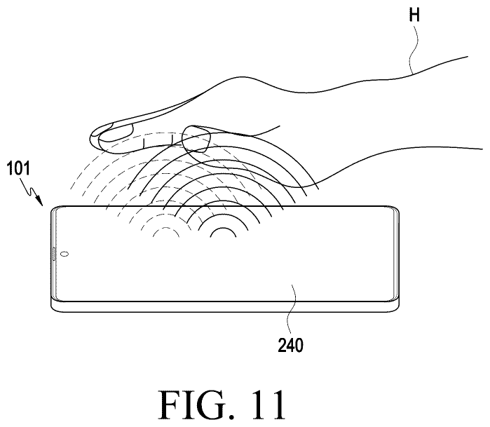

FIG. 11 is a state view illustrating a gesture detection operation of an electronic device 101 according to an embodiment of the disclosure.

Referring to FIG. 11, in an electronic device 101 according to an embodiment, the antenna array (e.g., the antenna array 530 of FIG. 5) may be configured to transmit or receive a radar signal.

The display panel 240 according to an embodiment may display a visual screen on the front surface, and components such as driving circuits for displaying the screen may be disposed on the rear surface. The antenna array 530 according to an embodiment may be disposed overlapping the display panel 240 to detect a gesture corresponding to a hand (H) occurring in the front direction of the screen displayed on the display panel 240. The electronic device 101 according to an embodiment may use a gesture corresponding to the hand (H) detected through the antenna array 530 as an input interface.

The electronic device 101 according to an embodiment may be various types of devices such as a portable communication device (e.g., a smartphone) or a wearable device (e.g., a smart watch or smart glasses).

Technical objects to be achieved herein are not limited to the foregoing technical objects, and other technical objects not mentioned may be clearly understood by those skilled in the art from the following description.

Effects obtainable from the disclosure are not limited to the above-mentioned effects, and other effects not mentioned may be clearly understood by those skilled in the art from the following description.

According to an embodiment of the disclosure, an electronic device 101 may include a display panel 240 including a plurality of pixels, an antenna array 830 and 840 disposed to overlap the display panel 240, a connection board 330 coupled to one side of the display panel 240, a display driver circuit 340 disposed on the connection board 330 and configured to drive the plurality of pixels to display a screen on the display panel 240, a first circuit board 220, a second circuit board 310 extending to connect between the first circuit board 220 and the connection board 330, a signal processing circuit 510 disposed on the first circuit board 220, a first front-end circuit 810 and 520 disposed on the connection board 330 to be positioned on one side of the display driver circuit 340 and operatively connected to the signal processing circuit 510 and the antenna array 830 and 840, and a second front-end circuit 820, 520 disposed on the connection board 330 to be positioned on another side of the display driver circuit 340 and operatively connected to the signal processing circuit 510 and the antenna array 830 and 840.

In the electronic device 101 according to an embodiment, the first front-end circuit 810 and 520 and the second front-end circuit 820, 520 may be configured to transmit to or receive from the antenna array 830 and 840 a radar signal radiated or received through the antenna array 830 and 840.

In the electronic device 101 according to an embodiment, the signal processing circuit 510 may be configured to transmit or receive an intermediate frequency (IF) signal with the first front-end circuit 810 and 520 or the second front-end circuit 820, 520.

In the electronic device 101 according to an embodiment, the radar signal may be set to a frequency included in a first frequency band, and the IF signal may be set to a frequency included in a second frequency band, which is relatively lower than the first frequency band.

In the electronic device 101 according to an embodiment, the first front-end circuit 810 and 520 and the second front-end circuit 820, 520 may include at least one of a chirp generator generating a chirp transmitted to the antenna array 830 and 840, an amplifier amplifying a radar signal radiated or received through the antenna array 830 and 840, or a mixer mixing the radar signal.

In the electronic device 101 according to an embodiment, the connection board 330 may be a film positioned at a side or rear surface of the display panel 240, and the connection board 330 may be coupled by being bonded to the display panel 240 or the second circuit board 310.

In the electronic device 101 according to an embodiment, the antenna array 830 and 840 may be configured to transmit or receive a signal corresponding to a millimeter wave (mmWave) to detect a gesture occurring in front of the display panel 240.

In the electronic device 101 according to an embodiment, the antenna array 830 and 840 may include at least one transmission patch 533 and at least one reception patch 537.

In the electronic device 101 according to an embodiment, the display driver circuit 340 may have a shape extending in a direction crossing the direction in which the connection board 330 extends to the one side of the display panel 240.

In the electronic device 101 according to an embodiment, the first front-end circuit 810 and 520 and the second front-end circuit 820, 520 may be respectively positioned at the one side and the other side of the display driver circuit 340 along the direction in which the display driver circuit 340 extends.

In the electronic device 101 according to an embodiment, the first front-end circuit 810 and 520 may be operatively connected to at least one transmission patch 533 of the antenna array 830 and 840, and the second front-end circuit 820, 520 may be operatively connected to at least one reception patch 537 of the antenna array 830 and 840.

In the electronic device 101 according to an embodiment, the second front-end circuit 820, 520 may be connected to the first front-end circuit 810 and 520 to receive from the first front-end circuit 810 and 520 a signal related to a transmission signal radiated through the at least one transmission patch 533.

In the electronic device 101 according to an embodiment, the first front-end circuit 810 and 520 may be operatively connected to at least one first transmission patch 533 and at least one first reception patch 537 of the antenna array 830 and 840, and the second front-end circuit 820, 520 may be operatively connected to at least one second transmission patch 533 and at least one second reception patch 537 of the antenna array 830 and 840.

In the electronic device 101 according to an embodiment, the first front-end circuit 810 and 520 and the second front-end circuit 820, 520 may be connected to each other to transmit or receive a signal related to the sync of a radar signal radiated through or received from the antenna array 830 and 840.

In the electronic device 101 according to an embodiment, a power management integrated circuit (PMIC) may be disposed on the first circuit board 220 or the second circuit board 310, and the first front-end circuit 810 and 520 or the second front-end circuit 820, 520 may receive power from the PMIC.

An electronic device 101 according to an embodiment of the disclosure may include a display panel 240 including a plurality of pixels, an antenna array 830 and 840 disposed to overlap the display panel 240, a first circuit board 220, a signal processing circuit 510 disposed on the first circuit board 220, a second circuit board 310 extending to connect between the first circuit board 220 and the display panel 240, a display driver circuit 340 disposed on the second circuit board 310 and configured to drive the plurality of pixels to display a screen on the display panel 240, a first front-end circuit 810 and 520 disposed on the second circuit board 310 to be positioned on one side of the display driver circuit 340 and operatively connected to the signal processing circuit 510 and the antenna array 830 and 840, and a second front-end circuit 820, 520 disposed on the second circuit board 310 to be positioned on another side of the display driver circuit 340 and operatively connected to the signal processing circuit 510 and the antenna array 830 and 840.

In the electronic device 101 according to an embodiment, the first front-end circuit 810 and 520 and the second front-end circuit 820, 520 may be configured to transmit to or receive from the antenna array 830 and 840 a radar signal radiated or received through the antenna array 830 and 840.

In the electronic device 101 according to an embodiment, the signal processing circuit 510 may be configured to transmit or receive an intermediate frequency (IF) signal with the first front-end circuit 810 and 520 or the second front-end circuit 820, 520.

In the electronic device 101 according to an embodiment, the display driver circuit 340 may have a shape extending in a direction crossing the direction in which the second circuit board extends between the first circuit board and the display panel 240, and the first front-end circuit 810 and 520 and the second front-end circuit 820, 520 may be respectively positioned at the one side and the other side of the display driver circuit 340 along the direction in which the display driver circuit 340 extends.

In the electronic device 101 according to an embodiment, the display driver circuit 340, the first front-end circuit 810 and 520 and the second front-end circuit 820, 520 may be disposed on a film 330 included in the second circuit board, and the film 330 may be coupled by being bonded to one side of the display panel 240.

The electronic device according to an embodiment may be one of various types of electronic devices. The electronic devices may include, for example, a portable communication device (e.g., a smart phone), a computer device, a portable multimedia device, a portable medical device, a camera, an electronic device, or a home appliance. An electronic device according to an embodiment of the disclosure is not limited to the above-described devices.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a display panel including a plurality of pixels;
an antenna array disposed to overlap the display panel;
a connection board coupled to a side of the display panel;
a display driver circuit disposed on the connection board and configured to drive the plurality of pixels to display a screen on the display panel;
a first circuit board;
a second circuit board configured to connect between the first circuit board and the connection board;
a signal processing circuit disposed on the first circuit board;
a first front-end circuit disposed on the connection board to be positioned on a first side of the display driver circuit and operatively connected to the signal processing circuit and the antenna array; and
a second front-end circuit disposed on the connection board to be positioned on a second side of the display driver circuit and operatively connected to the signal processing circuit and the antenna array.

2. The electronic device of claim 1,
wherein the first front-end circuit and the second front-end circuit are configured to transmit to or receive from the antenna array a radar signal radiated or received through the antenna array.

3. The electronic device of claim 2,
wherein the signal processing circuit is configured to transmit or receive an intermediate frequency (IF) signal with the first front-end circuit or the second front-end circuit.

4. The electronic device of claim 3,
wherein the radar signal is set to a frequency included in a first frequency band, and
wherein the IF signal is set to a frequency included in a second frequency band, which is lower than the first frequency band.

5. The electronic device of claim 1,
wherein the first front-end circuit and the second front-end circuit include at least one of a chirp generator configured to generate a chirp transmitted to the antenna array, an amplifier configured to amplify a radar signal radiated or received through the antenna array, or a mixer configure to mix the radar signal.

6. The electronic device of claim 1,
wherein the connection board comprises a film positioned at a side or a rear surface of the display panel, and wherein the connection board is coupled by being bonded to the display panel or the second circuit board.

7. The electronic device of claim 1,
wherein the antenna array is configured to transmit or receive a signal corresponding to a millimeter wave (mmWave) to detect a gesture occurring in front of the display panel.

8. The electronic device of claim 1,
wherein the antenna array includes at least one transmission patch and at least one reception patch.

9. The electronic device of claim 1,
wherein the display driver circuit has a shape extending in a first direction crossing a second direction in which the connection board extends to the side of the display panel.

10. The electronic device of claim 9,
wherein the first front-end circuit and the second front-end circuit are respectively positioned at the first side and the second side of the display driver circuit along the first direction in which the display driver circuit extends.

11. The electronic device of claim 1,
wherein the first front-end circuit is operatively connected to at least one transmission patch of the antenna array, and
wherein the second front-end circuit is operatively connected to at least one reception patch of the antenna array.

12. The electronic device of claim 11, wherein the second front-end circuit is connected to the first front-end circuit to receive from the first front-end circuit a signal related to a transmission signal radiated through the at least one transmission patch.

13. The electronic device of claim 1,
wherein the first front-end circuit is operatively connected to at least one first transmission patch and at least one first reception patch of the antenna array, and
wherein the second front-end circuit is operatively connected to at least one second transmission patch and at least one second reception patch of the antenna array.

14. The electronic device of claim 13,
wherein the first front-end circuit and the second front-end circuit are connected to each other to transmit or receive a signal related to sync of a radar signal radiated through or received from the antenna array.

15. The electronic device of claim 1,
wherein a power management integrated circuit (PMIC) is disposed on the first circuit board or the second circuit board, and
wherein the first front-end circuit or the second front-end circuit is configured to receive power from the PMIC.

16. An electronic device comprising:
a display panel including a plurality of pixels;
an antenna array disposed to overlap the display panel;
a first circuit board;
a signal processing circuit disposed on the first circuit board;
a second circuit board extending to connect between the first circuit board and the display panel;
a display driver circuit disposed on the second circuit board and configured to drive the plurality of pixels to display a screen on the display panel;
a first front-end circuit disposed on the second circuit board to be positioned on a first side of the display driver circuit and operatively connected to the signal processing circuit and the antenna array; and
a second front-end circuit disposed on the second circuit board to be positioned on a second side of the display driver circuit and operatively connected to the signal processing circuit and the antenna array.

17. The electronic device of claim 16,
wherein the first front-end circuit and the second front-end circuit are configured to transmit to or receive from the antenna array a radar signal radiated or received through the antenna array.

18. The electronic device of claim 17,
wherein the signal processing circuit is configured to transmit or receive an intermediate frequency (IF) signal with the first front-end circuit or the second front-end circuit.

19. The electronic device of claim 16,
wherein the display driver circuit has a shape extending in a direction crossing a direction in which the second circuit board extends to the first side of the display panel, and
wherein the first front-end circuit and the second front-end circuit are respectively positioned at the first side and the second side of the display driver circuit along the direction in which the display driver circuit extends.

20. The electronic device of claim 16,
wherein the display driver circuit, the first front-end circuit and the second front-end circuit are disposed on a film included in the second circuit board, and
wherein the film is coupled by being bonded to a side of the display panel.
